(19) United States
(12) Patent Application Publication
(10) Pub. No.: US 2026/0249486 A1
(43) Pub. Date: Aug. 27, 2026

(54) Material Handling Device

(71) Applicant: The Boeing Company, Arlington, VA (US)

(72) Inventors: Dustin Greene, Aledo, TX (US); John Manning Holder, Plano, TX (US); Lauren Greene, Aledo, TX (US)

(21) Appl. No.: 19/063,676

(22) Filed: Feb. 26, 2025

(51) Int. Cl. B25J 15/06; B65G 1/04

(52) U.S. Cl. CPC B25J 15/0625; B65G 1/04

(57) ABSTRACT

A device to remove an object from a storage position. The device includes a surface and a suction device. The suction device includes a manifold and arms that extend outward from the manifold. An air pump moves the air from the manifold thereby causing air flow inward along the arms and into the manifold to create a suction force in the arms.

### TECHNOLOGICAL FIELD

The present disclosure relates generally to the field of material handling and, more specifically, to devices and methods that utilize suction power to connect to and move an object from a storage position.

### BACKGROUND

An order picker is a device used to receive objects from storage positions. The order picker generally includes a wheeled base, a lift mechanism, and a platform. The base is configured to be moved around a work surface, such as along the floor of a warehouse. The lift mechanism is connected to the base and platform and configured to elevate the platform to a desired height above the work surface. In use, a user is positioned on the platform. The platform is at a lowered position at the base to enable the user to drive the device along the floor of the work area to the desired location. In one example, the user drives along the floor of a warehouse to a specific shelf where an object is stored. Once in position, the user elevates the platform to position the user and the platform at the desired elevation. Once in this position, the user manually reaches out and grasps the object and moves it onto the platform. The platform (with the user) is then returned to the lowered position.

### SUMMARY

One aspect is directed to a device to remove an object from a storage position. The device comprises a surface. A suction device is positioned on the surface. The suction device comprises: a manifold and arms that extend outward from the manifold. Each of the arms comprises an inner end in communication with the manifold, an outer end, a channel that extends between the inner end and the outer end, and a valve that controls an amount of air that flows through the channel. An air pump moves the air from the manifold thereby causing air flow inward along the arms and into the manifold to create a suction force in the arms.

In some aspects, a rigid body extends around the manifold and the air pump with the body comprising a bottom that faces towards the surface, an opposing top, and intermediate lateral sides.

In some aspects, wheels are mounted to the body with one or more of the wheels extending outward from the top of the body and one or more of the wheels extending outward from the bottom of the body.

In some aspects, the arms extend outward from just one of the lateral sides of the body.

In some aspects, the arms are straight and aligned parallel to the surface.

In some aspects, a computing device is configured to: position the valves of a first set of the arms to enable the flow of air through the channels of the first set of arms; and simultaneously position the valves of a second set of the arms to prevent the flow of air through the channels of the second set of the arms.

In some aspects, a computing device is configured to increase the flow of air through the arms that are in contact with the device.

In some aspects, sensors are positioned to detect the flow of air through the channels of the arms.

In some aspects, one of the valves is connected to each of the arms and positioned between the inner end and the outer end of the arm of the arm.

One aspect is directed to a device to remove an object from a storage position. The device comprises a support with a surface. A suction device is positioned on the surface and comprises a manifold, arms with channels that extend outward from the manifold, and an air pump. A computing device comprising processing circuitry is configured to: activate the air pump and create a suction force at the arms; determine air flow through the arms; determine which of the one or more of the arms are in contact with the object; reduce the flow of air through the arms that are not in contact with the object; and continue the flow of air through the arms that are in contact with the object.

In some aspects, sensors are positioned along the arms to detect the flow of air along the arms.

In some aspects, valves are configured to adjust the flow of air through the arms with the valves adjustable between an open position and a closed position.

In some aspects, a body extends around the manifold and the air pump and with the arms extending outward from a side of the body.

In some aspects, the computing device is further configured to prevent the flow of the air through the arms that are not in contact with the object, and maintain a flow rate of the flow of the air through the arms that are in contact with the object.

One aspect is directed to a method of picking an object from a storage shelf. The method comprises: moving a suction device along a table; moving air from a manifold of the suction device and moving air into channels that extend through the arms; contacting one or more of the arms that extend outward from the suction device against the object; preventing air flow through the arms that are not in contact with the object; creating a suction force through the arms that are in contact with the object and connecting the arms to the object; and moving the suction device and the object that is connected to the arms onto the table 20.

In some aspects, moving the suction device and the object onto the table comprises moving the suction device and the object in a horizontal direction onto a top of the table.

In some aspects, the method further comprises: sensing a flow of the air through the arms; determining that the flow of air through one or more of the arms is below a threshold; and closing valves on the arms in which the flow of the air below the threshold.

In some aspects, the method further comprises: preventing the flow of the air through the arms that are not in contact with the object; and simultaneously increasing the suction force of the arms that are in contact with the object.

In some aspects, the method further comprises contacting seals at outer ends of the arms against the object and deforming a shape of the seals to conform to the object.

In some aspects, the method further comprises independently adjusting the flow of air through each of the arms.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is a schematic diagram of a device connected to a vehicle and being moved towards an object on a storage shelf.

FIG. 2 is an isometric view of a device.

FIG. 3 is a schematic side view of a device that includes a table and a section device.

FIG. 4 is an isometric view of a suction device.

FIG. 5 is a schematic side view of a suction system.

FIG. 6 is a schematic view of a computing device.

FIG. 7 is a flowchart diagram of a method of picking an object from a storage shelf.

FIG. 8 is a flowchart diagram of a method of picking an object from a storage shelf.

### DETAILED DESCRIPTION

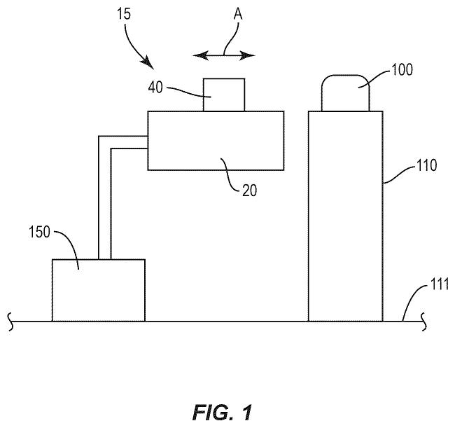

FIG. 1 illustrates a device 15 configured to connect to and move or otherwise pick an object 100 from a storage location. The device 15 includes a suction device 40 that is mounted on a surface. In the examples of FIG. 1, the surface is a top of a table 20. The suction device 40 moves as shown by arrow A relative to the surface to contact against the object 100. A vacuum is applied through the suction device 40 to connect to the object 100. While connected to the suction device 40, the object 100 is moved onto the surface. Once the object 100 is on the surface, the suction is removed to enable further handling of the object 100.

FIG. 1 illustrates one use context of the device 15 within a warehouse or other like storage facility. The device 15 is supported by a vehicle 150 such as an order picker or forklift. The vehicle 150 includes a lift mechanism, such as a scissor-lift assembly. In the example of FIG. 1, the device 15 is configured to be moved by the vehicle 150 into proximity of the object 100 where it is stored on a support member 110, such as a shelf or scaffold. The device 15 is elevated to the level of the object 100. Once positioned in proximity, the suction device 40 is moved relative to the table 20 and into contact with the object 100. The suction device 40 is then moved along the surface in an opposing direction to move the object 100 onto the surface. The object 100 can remain on the surface or can be offloaded by a user.

In some examples, the suction device 40 connects to and moves the object 100 horizontally from the storage location to the surface. This enables the object 100 to be slid from the storage position and onto the surface without vertically lifting the object 100. This horizontal movement facilitates maintaining the connection between the suction device 40 and the object 100 because the object is supported by the support member 110 and/or surface during the movement. Further, this prevents/reduces issues with the object 100 detaching and potentially falling to the floor.

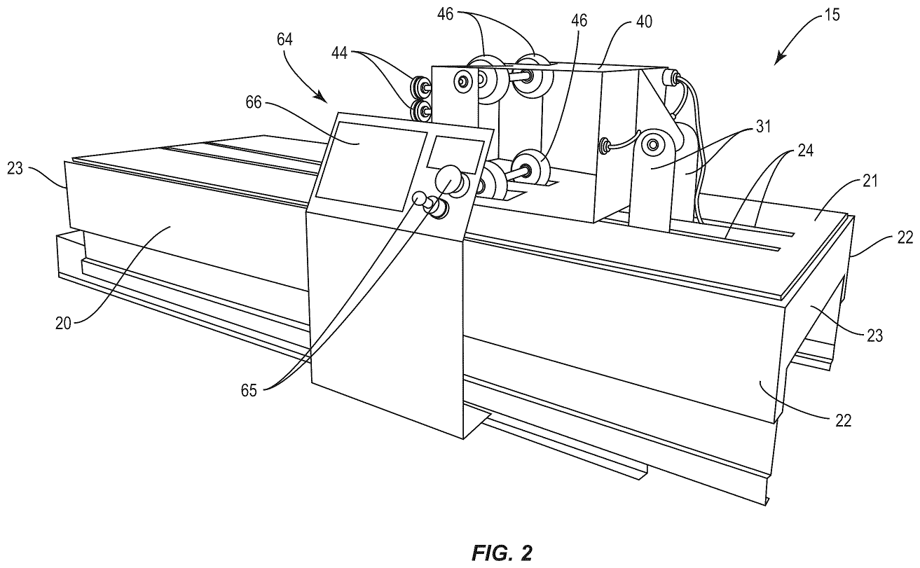

FIG. 2 illustrates a device 15 that includes a table 20 and a suction device 40. The table 20 includes a top 21 and opposing side walls 22. In some examples, the top 21 is substantially flat to enable the object 100 to slide across the table 20 when connected to the suction device 40. The table 20 includes opposing ends 23 with one or both ends 23 configured to engage with the vehicle 150.

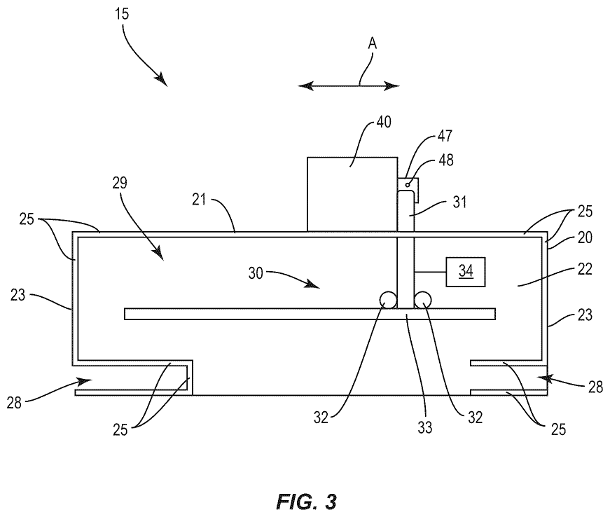

As schematically illustrated in FIG. 3, frame members 25 support one or more of the top 21 and side walls 22. An interior space 29 is formed between the top 21 and side walls 22. In some examples, receptacles 28 are formed at and extend into the interior space 29 from one or both ends 23. The receptacles 28 are formed by frame members 25 and are configured to receive the tines/arms of the vehicle 150.

A positioning system 30 is configured to position the suction device 40 relative to the table 20. The positioning system 30 includes one or more arms 31 that are connected to the suction device 40. In some examples, the arms 31 extend through slots 24 in the top 21 of the table 20. Gears 32 connect the arms 31 to a toothed rack 33. A motor 34 drives the gears 32 that engage with the teeth on the rack 33 to move the arms 31 as illustrated by arrow A along the length of the table 20. In some examples, the suction device 40 is configured to move across the entire length of the top 21 (i.e., from one end 23 to the other end 23). In other examples, the suction device 40 moves across a limited section of the top 21.

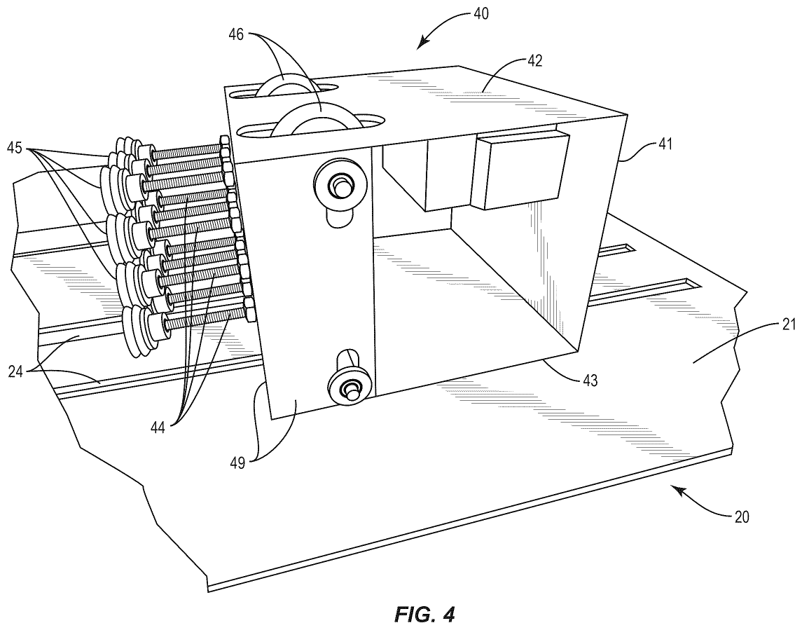

FIG. 4 illustrates a suction device 40 positioned on the top 21 of table 20. The suction device 40 includes a body 41 that extends around and forms an exterior. In some examples, the body 41 is constructed from a rigid material such as various metals or plastic to protect the components within the interior. The body 41 includes a top 42, bottom 43, and lateral sides 49. Arms 44 extend outward from one or more of the lateral sides 49. Seals 45 are positioned at the outer ends of the arms 44.

One or more wheels 46 extend outward from one or both of the top 42 and bottom 43. The wheels 46 facilitate the movement of the suction device 40 across the top 21 of the table 20. In some examples, wheels 46 are positioned on just the bottom 43. In other examples, wheels 46 are positioned on both the bottom 43 and the top 42. The suction device 40 includes a gear box 47 (see FIG. 3) that is powered to rotate the body 41 substantially 180° selectively position one of the top 42 or the bottom 43 against the top 21 of the table 20. This enables the arms 44 to be positioned outward in front of the suction device 40 as the suction device 40 is moving in a first direction (e.g., the bottom 43 is facing towards the table top 21), and then rotated such that the arms 44 face outward in front while moving in a second direction (e.g., the top 42 is facing towards the table top 21).

In use, the suction device 40 is moved across the top 21 and the arms 44 are moved into contact with the object 100. This brings the seals 45 that are positioned at the ends of the arms 44 into contact with the object 100. Suction is applied through the arms 44 to connect the arms 44 to the object 100. In some examples, the seals 45 are constructed from a flexible material such as rubber that conforms to the shape of the object 100. This flexibility eliminates and/or lessens an amount of ambient air getting pulled into the suction system 50.

In some examples, the arms 44 include a constriction along the length that creates a venturi effect with the air flow along the channels 55. The constriction causes a drop in air pressure and an increase in velocity. The distal section of the channels 55 (i.e., the section between the exposed ends and the constriction) has a higher air pressure that flows inward towards a proximal section of the channels 55 (i.e., the section between the constriction and the manifold 52). This venturi air flow assists to pull air into the channels 55 of the arms 44 and create airflow.

In some examples, the arms 44 are substantially straight and are aligned parallel with the top 21 of the table 20. This positioning can assist with the connection to the object 100 and the horizontal movement of the object 100.

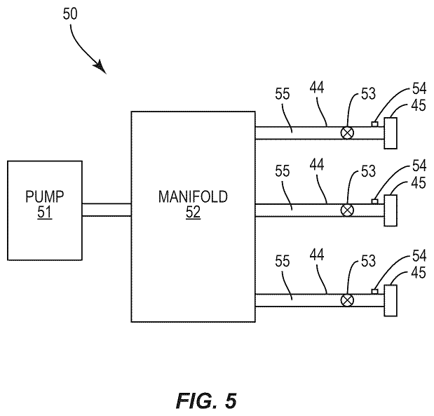

FIG. 5 schematically illustrates the suction system 50 of the suction device 40 that includes a pump 51 that applies a vacuum to a manifold 52. The arms 44 extend outward from the manifold 52. The arms 44 are hollow with an interior channel 55 along which the air flows into the manifold 52. The number of arms 44 can vary with one specific example including twelve arms 44.

Sensors 54 are positioned along the arms 44 to detect the flow of air along the channels 55. For each arm 44, the flow can vary between a first rate when the arm 44 is positioned away from the object 100 (i.e., in a non-contact position) and a second rate when the arm 44 is positioned against the object 100 (i.e., in a contact position). The flow rate provides for an indication of whether the arm 44 is connected to the object 100. In some examples, the flow rate is substantially zero in the contact position. In other examples, the flow rate is above zero, but substantially less than the flow rate in the non-contact position.

Valves 53 are positioned to control the extent of air flow through the channels 55. The valves 53 are configured to be positioned between an open position to enable the flow of air and a closed position to prevent the flow. In some examples, the closed position completely prevents the flow of air. In other examples, the closed position limits the flow of air but does not completely shut off air flow. The valves 53 are used to shut off the air flow when the arm 44 is not connected to the object 100. A variety of different valves 53 can be used with one example being a solenoid valve.

In some examples, when the sensors 54 detect the flow of air through the channels 55 is below a threshold, it is determined that the corresponding arm 44 is in contact with the object 100 and the valve 53 remains in the open position to continue to allow air flow along the channel 55. If the flow of air is above the threshold, it is determined that the corresponding arm 44 is not in contact with the object 100 and the valve 53 is closed to prevent ambient air from being pulled into the channel 55.

The single manifold 52 enables the vacuum to be applied independently to each of the arms 44. When air flow that is pulled through each of the open arms 44 can be the same as the vacuum is evenly applied to each of the arms 44. When one or more of the valves 53 is closed, the vacuum is applied to just the remaining arms 44. This results in the flow rate through the remaining arms 44 being greater than the flow rate when all the arms 44 are open. This provides for a greater suction connection with the arms 44 that are in contact with the object 100. The arms 44 that are not connected are shut off by their respective valve 52. This prevents the inflow of ambient air through the arm 44 that could weaken the vacuum amount in the other arms 44.

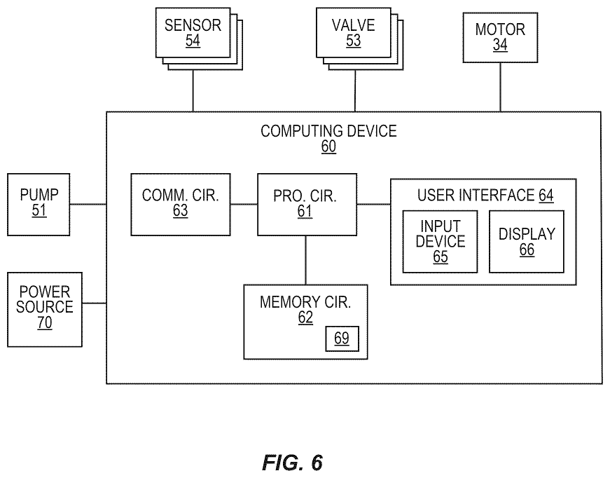

FIG. 6 illustrates a computing device 60 that controls the operation of the device 15. The computing device 60 can include one or more of each of a number of components such as, for example, processing circuitry 61 (e.g., processor unit), a memory circuitry 62 (e.g., storage device), communication circuitry 63, and a user interface 64. The computing device 60 receives signals from the sensors 54 indicating the flow of air through the respective arm 44. The computing device 60 adjusts the valves 53 depending upon the sensed air flow in the respective arms 44. The computing device 60 adjusts the pump 51 to adjust the air flow to ensure there is an effective connection with the object 100. The computing device 60 is also configured to control the motor 34 to move the suction device 40 relative to the table 20. A user interface 64 includes one or more input device 65 to enable a user to control aspects of the process. One or more displays 66 enable the display of relevant information to the user.

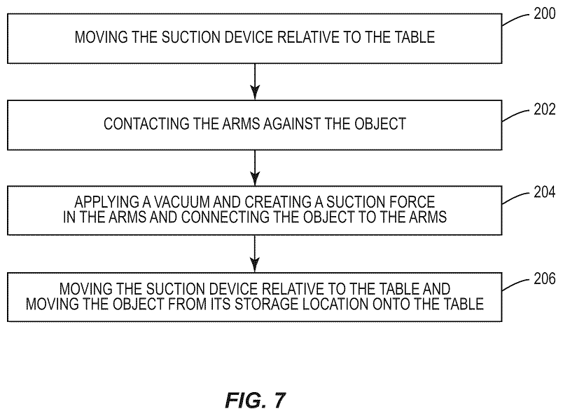

FIG. 7 illustrates a method of using the device 15 to pick an object from a storage location. The method includes moving the suction device 40 relative to the table (block 200). The suction device 40 is moved to contact the arms 44 against the object 100 (block 202). A vacuum is applied that creates a suction force in the arms 44 that connects the object to the arms 44 (block 204). Once connected, the suction device 40 is moved relative to the table 20 to move the object from its storage location onto the table (block 206).

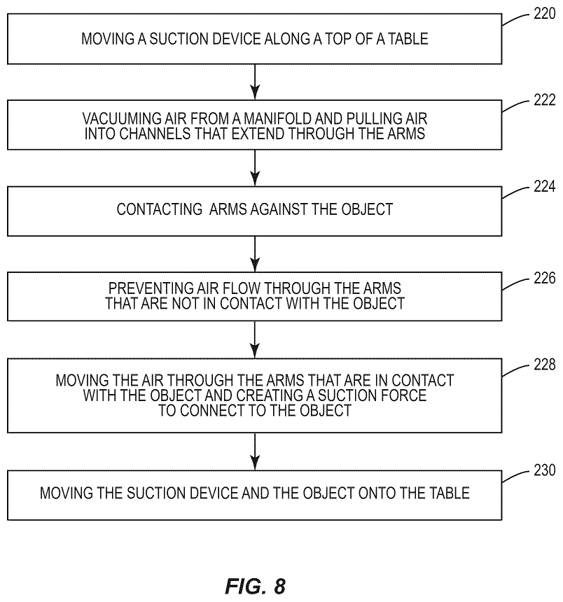

FIG. 8 illustrates a method of picking an object 100 from a storage shelf. The method includes moving a suction device 40 along a top of a table 20 (block 220). Air is moved from a manifold 52 of the suction device 40 and air is moved into channels 55 that extend through the arms 44 (block 222). One or more of the arms 44 that extend outward from the suction device 40 are contacted against the object 100 (block 224). The method includes preventing air flow through the arms 44 that are not in contact with the object 100 (block 226) and moving the air through the arms 44 that are in contact with the object 100 and creating a suction force to connect to the object 100 (block 228). The suction device 40 and the connected object 100 are moved onto the top 21 of the table 20 (block 230).

In some examples, the suction device 40 moves horizontally across the table 20. This results in the object 100 that is connected to the suction device 40 also moving horizontally. This enables the object 100 to be slid from its storage position and onto the top 21 of the table 20 without vertically lifting the object 100. In some examples, the horizontal movement is better to maintain the contact between the arms 44 and object than movement that requires vertical lifting. The better contact maintains the object 100 connected to the arms 44 and prevents the object 100 from detaching and potentially falling to the floor.

In some examples, the device 15 includes a power source 70 to provide power to the electrical components. The power source 70 can be mounted at various locations, such as within the interior space of the table 20 where it is protected. The power source 70 can include various configurations, such as one or more batteries. Additionally or alternatively, the device 15 is configured to connect to and receive power from the vehicle 150.

The computing device 60 is configured to control the operation of the device 15. The processing circuitry 61 may be composed of one or more processors alone or in combination with one or more memories. The processing circuitry 61 is generally computer hardware that is capable of processing information such as, for example, data, computer programs and/or other suitable electronic information. The processing circuitry 61 is composed of a collection of electronic circuits some of which may be packaged as an integrated circuit or multiple interconnected integrated circuits (an integrated circuit at times more commonly referred to as a “chip”). The processing circuitry 61 may be configured to execute computer programs 69 with programming instructions which may be stored onboard the processing circuitry 61 or otherwise stored in the memory circuitry 62 (of the same or another device).

The processing circuitry 61 may be a number of processors, a multi-core processor or some other type of processor, depending on the particular implementation. Further, the processing circuitry 61 may be implemented using a number of heterogeneous processor systems in which a main processor is present with one or more secondary processors on a single chip. As another illustrative example, the processing circuitry 61 may be a symmetric multi-processor system containing multiple processors of the same type. In yet another example, the processing circuitry 61 may be embodied as or otherwise include one or more ASICs, FPGAs or the like. Thus, although the processing circuitry 61 may be capable of executing a computer program to perform one or more functions, the processing circuitry 61 of various examples may be capable of performing one or more functions without the aid of a computer program. In either instance, the processing circuitry 61 may be appropriately programmed to perform functions or operations according to example implementations of the present disclosure.

The memory circuitry 62 is generally computer hardware that is capable of storing information such as, for example, data, computer programs (e.g., computer-readable program code) and/or other suitable information either on a temporary basis and/or a permanent basis. The memory circuitry 62 may include volatile and/or non-volatile memory and may be fixed or removable. Examples of suitable memory circuitry 62 include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory circuitry 62 may be referred to as a computer-readable storage medium. The computer-readable storage medium is a non-transitory device capable of storing information and is distinguishable from computer-readable transmission media such as electronic transitory signals capable of carrying information from one location to another. Computer-readable medium as described herein may generally refer to a computer-readable storage medium or computer-readable transmission medium.

Computing device 60 also includes communications circuitry 63 configured to transmit and/or receive information. The communications circuitry 63 may be configured to transmit and/or receive information by physical (wired) and/or wireless communications links. Examples of suitable communication interfaces include a network interface controller (NIC), wireless NIC (WNIC) or the like. The communications circuitry 63 may have one or more transmitters and/or receivers.

A user interface 64 is included to enable input from a user. The user interface 64 can include one or more input devices 65 such as but not limited to a keypad, touchpad, roller ball, and joystick. The user interface 64 also includes one or more displays 66 for displaying information such as but not limited to data regarding the picking process, status of the vacuum, and position of the suction device 40.

As will be appreciated by those of ordinary skill in the art without undue experimentation, program code instructions 69 may be loaded onto a computing device 60 or other programmable apparatus from a computer-readable storage medium to produce a particular machine, such that the particular machine becomes a means for implementing the functions specified herein. These program code instructions 69 may also be stored in a computer-readable storage medium that can direct a computer, a processing circuitry or other programmable apparatus to function in a particular manner to thereby generate a particular machine or particular article of manufacture. The program code instructions 69 may be retrieved from a computer-readable storage medium and loaded into a computer, processing circuitry or other programmable apparatus to configure the computing device 60, processing circuitry 61 or other programmable apparatus to execute operations to be performed on or by the computer, processing circuitry or other programmable apparatus.

In some examples, the device 15 just includes the suction device 40. The device 15 is configured to be positioned on a surface of a support member where it is able to move to different positions for connecting to an object 100 and moving the object 100 onto the support member.

The device 15 is an improvement over existing devices. The device 15 is configured to facilitate connecting to and moving an object. This reduces/eliminates the user from having to manually handle the object from the storage position onto the platform. This reduces/eliminates the user from having to reach out and grasp the object while they are standing on the platform. The device 15 maintains the user on the platform during the handling of the objects 100.

By the term “substantially” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A device to remove an object from a storage position, the device comprising:
a surface;
a suction device positioned on the surface, the suction device comprising:
a manifold;
arms that extend outward from the manifold, the arms comprising:
an inner end in communication with the manifold;
an outer end;
a channel that extends between the inner end and the outer end;
a valve that controls an amount of air that flows through the channel; and
an air pump that moves the air from the manifold thereby causing air flow inward along the arms and into the manifold to create a suction force in the arms.

2. The device of claim 1, further comprising a rigid body that extends around the manifold and the air pump, the body comprising a bottom that faces towards the surface, an opposing top, and intermediate lateral sides.

3. The device of claim 2, further comprising wheels mounted to the body with one or more of the wheels extending outward from the top of the body and one or more of the wheels extending outward from the bottom of the body.

4. The device of claim 2, wherein the arms extend outward from just one of the lateral sides of the body.

5. The device of claim 1, wherein the arms are straight and aligned parallel to the surface.

6. The device of claim 1, further comprising a computing device configured to:
position the valves of a first set of the arms to enable the flow of air through the channels of the first set of the arms; and
simultaneously position the valves of a second set of the arms to prevent the flow of air through the channels of the second set of the arms.

7. The device of claim 1, further comprising a computing device configured to increase the flow of air through the arms that are in contact with the device.

8. The device of claim 1, further comprising sensors positioned to detect the flow of air through the channels of the arms.

9. The device of claim 1, wherein one of the valves is connected to each of the arms and positioned between the inner end and the outer end of the arm of the arm.

10. A device to remove an object from a storage position, the device comprising:
a support with a surface;
a suction device positioned on the surface, the suction device comprising:
a manifold;
arms with channels that extend outward from the manifold;
an air pump;
a computing device comprising processing circuitry configured to:
activate the air pump and create a suction force at the arms;
determine air flow through the arms;
determine which of the one or more of the arms are in contact with the object;
reduce the flow of air through the arms that are not in contact with the object; and
continue the flow of air through the arms that are in contact with the object.

11. The device of claim 10, further comprising sensors positioned along the arms to detect the flow of air along the arms.

12. The device of claim 10, further comprising valves configured to adjust the flow of air through the arms with the valves adjustable between an open position and a closed position.

13. The device of claim 10, further comprising a body that extends around the manifold and the air pump, and with the arms extending outward from a side of the body.

14. The device of claim 10, wherein the computing device is further configured to prevent the flow of the air through the arms that are not in contact with the object and maintain a flow rate of the air through the arms that are in contact with the object.

15. A method of picking an object from a storage shelf, the method comprising:
moving a suction device along a table;
moving air from a manifold of the suction device and moving air into channels that extend through arms that extend outward from the manifold;
contacting one or more of the arms that extend outward from the suction device against the object;
preventing air flow through the arms that are not in contact with the object; and
creating a suction force in the arms that are in contact with the object and connecting the arms to the object; and
moving the suction device and the object that is connected to the arms onto the table.

16. The method of claim 15, wherein moving the suction device and the object onto the table comprises moving the suction device and the object in a horizontal direction onto a top of the table.

17. The method of claim 15, further comprising:
sensing a flow of the air through the arms;
determining that the flow of air through one or more of the arms is below a threshold; and
closing valves on the arms in which the flow of the air below the threshold.

18. The method of claim 15, further comprising:
preventing the flow of the air through the arms that are not in contact with the object; and
simultaneously increasing the suction force of the arms that are in contact with the object.

19. The method of claim 15, further comprising contacting seals at outer ends of the arms against the object and deforming a shape of the seals to conform to the object.

20. The method of claim 15, further comprising independently adjusting the flow of air through each of the arms.
